(19) United States
(12) Patent Application Publication
(10) Pub. No.: US 2012/0085789 A1
(43) Pub. Date: Apr. 12, 2012

(54) PACKAGE SYSTEM INCLUDING A FITMENT WITH ANTI-FLOW BLOCKING AND SHUT-OFF VALVE FOR USE WITH DISPENSING DEVICES

(75) Inventor: Barry Pritchard, Nazareth, PA (US)

(73) Assignee: FRES-CO SYSTEM USA, INC., Telford, PA (US)

(21) Appl. No.: 13/236,752

(22) Filed: Sep. 20, 2011

Related U.S. Application Data
(60) Provisional application No. 61/390,872, filed on Oct. 7, 2010.

(51) Int. Cl. B67D 7/78

(52) U.S. Cl. 222/464.1

(57) ABSTRACT

A package for enabling the dispensing a flowable material therefrom by use of dispensing apparatus, e.g., a soft drink making machine. The package is in the form of a flexible bag having wall portions defining an internal cavity and a fitment secured to at least one wall portion. The fitment is arranged to receive a probe of the dispensing apparatus to pump the contents of the package through the fitment. The fitment includes an anti-blocking member which prevents the walls of the package from collapsing to block the fitment when the contents of the package are pumped out. The fitment also includes a valve which is normally closed and which opens upon the creation of negative pressure within the fitment as occasioned by the operation of the pumping mechanism.

### CROSS-REFERENCE TO RELATED APPLICATIONS

This application claims priority from Provisional Application Ser. No. 61/390,872, filed on Oct. 7, 2010, entitled Package System With Anti-Flow Blocking And Shut-Off Valve For Use With Dispensing Devices, which application is assigned to the same assignee as this application and whose disclosure is incorporated by reference herein.

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### BACKGROUND OF THE INVENTION

This invention relates to flexible packages and more particularly to flexible package systems for use with dispensing apparatus, e.g., beverage making machines, for dispensing flowable materials.

Various soft-drink making/dispensing apparatus today make use of what is referred to as “bag-in-box” packages for holding the drink-making ingredient, e.g., syrup. In particular, the bag-in-box package includes an outer protective container (the “box”) and an inner flexible material container (the “bag”). The outlet of the package is typically in the form of a fitment which mounted on a portion of the wall of the flexible package and is in fluid communication with its interior. The fitment is arranged to be pierced by a probe forming a portion of the beverage making apparatus. The probe is connected to a pumping mechanism, e.g., a pump, of the beverage making apparatus so that the contents of the package can be dispensed (i.e., pumped out). The pumping action causes the walls of the bag to collapse inward as the bag's contents are pumped out. In order to ensure that the collapsing walls of the bag don't block the fitment, thereby preventing further dispensing, it is a common practice to make use of some anti-blocking device as part of the fitment or as an adjunct to the fitment. Such devices ensure that the entire fluid contents of the package can be pumped out without any impediment.

While the foregoing devices are generally suitable for their intended purposes, i.e., to ensure that the entire contents of the package can be readily dispensed, they do not serve to prevent leakage of the package's contents. Accordingly a need exists for a fitment that achieves both of those ends. The subject invention addresses that need by providing a fitment for a bag-in-box arrangement, with the fitment including anti-blocking features and a valve which prevents the contents of the bag from gaining egress through the fitment until the pumping mechanism is activated.

### SUMMARY OF THE INVENTION

In accordance with one aspect of this invention there is provided a package for use with a dispensing apparatus, e.g., a soft-drink dispensing machine, to dispense a flowable material, e.g., syrup, therefrom. The package comprises a flexible bag having plural wall portions defining an internal cavity and a fitment secured to at least one of the wall portions. The fitment is arranged to receive a probe of the dispensing apparatus having a pumping mechanism to pump the contents of the package through the fitment. The fitment comprises an anti-blocking member, e.g., an elongate member of generally cruciform shape adapted for preventing wall portions of the package from collapsing to block the fitment when the contents of the package are pumped out. The fitment also comprises a valve, e.g., a hollow tubular member having plural ports and an elastic band covering the ports. The valve is normally closed, but opens upon the creation of negative pressure within the fitment when the pumping mechanism of the dispensing apparatus is operated.

In accordance with another aspect of this invention there is provided a fitment for use in a package. The package is arranged for use with a dispensing apparatus to dispense a flowable material therefrom and comprises a flexible bag having plural wall portions defining an internal cavity. The fitment is arranged to be secured to at least one of the wall portions of the package and is also arranged to receive a probe of the dispensing apparatus. The dispensing apparatus includes a pumping mechanism to pump the contents of the package through the fitment. The fitment comprises an anti-blocking member arranged for preventing wall portions of the package from collapsing to block the fitment when the contents of the package are pumped out and a valve which is normally closed and which is arranged to open upon the creation of negative pressure within the fitment as occasioned by the operation of the pumping mechanism.

### DESCRIPTION OF THE DRAWING

FIG. 1 is a side elevation view, partially in section, showing one exemplary embodiment of a flexible package constructed in accordance with this invention;

FIG. 2 is a sectional view taken along lines 2-2 of FIG. 1;

FIG. 3 is a sectional view taken along lines 3-3 of FIG. 1;

FIG. 4 is a side elevation view, partially in section, showing the package of FIG. 1 ready to be used to dispense its contents; and

FIG. 5 is a side elevation view like that of FIG. 4 showing the package of FIG. 1 during use to dispense its contents.

### DETAILED DESCRIPTION OF THE PREFERRED EMBODIMENT

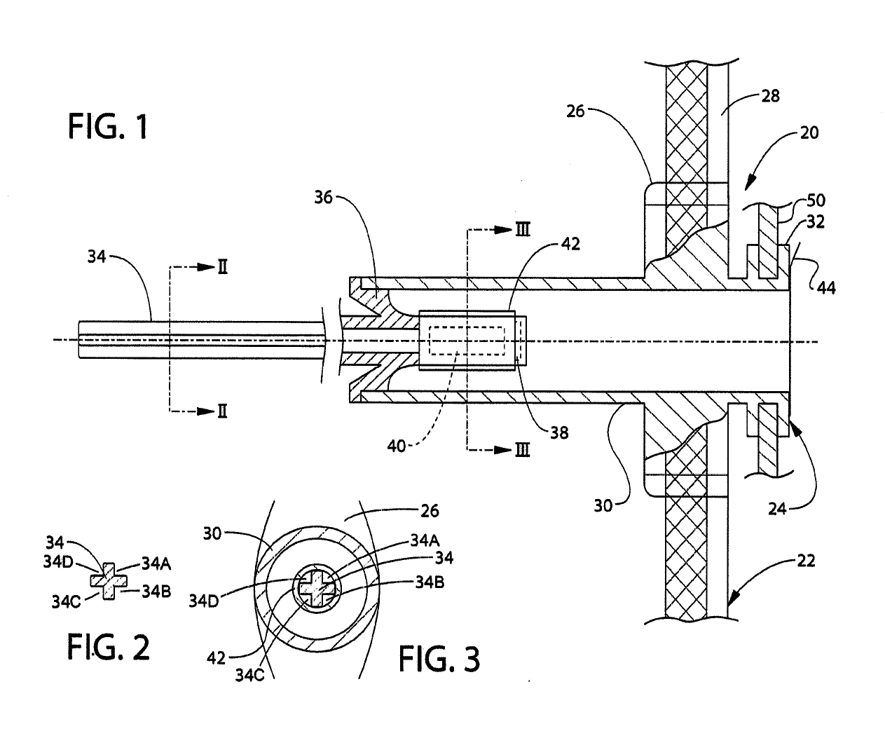

Referring now to the various figures of the drawing wherein like reference characters refer to like parts, there is shown in FIG. 1 an exemplary embodiment of a package 20 constructed in accordance with this invention. The package comprises a flexible bag 22 and a fitment 24. The bag includes plural wall portions, formed of a flexible material, e.g., plastic film, which together define an internal chamber or cavity for holding a flowable product therein. The bag 22 can be of any suitable construction. One particularly suitable construction is like that shown and claimed in my published application US2005/0211726, whose disclosure is incorporated by reference herein.

The fitment 24 has a generally boat shaped base section 26 sealed between contiguous wall portions 28 of the bag, an inner tubular section 30 and an outer collar section 32. The outer collar section is arranged to be received within a recess of a drawer forming a portion of the dispensing apparatus and to a probe, also forming a portion of the dispensing apparatus. Thus, when the package is so connected and the pump of the dispensing apparatus operated, the flowable contents of the package are dispensed through the fitment.

In order to prevent the collapsing walls of the package from blocking the fitment, and thus interfering with the dispensing operation, the fitment includes an anti-flow blocking member 34. That member is fixedly mounted at the inner end of the tubular section 30 of the fitment so that it is located within the hollow interior (cavity) in the bag holding the product, e.g., soft drink making syrup, to be dispensed. As best seen in FIGS. 1-3, the anti-flow blocking member 34 is an elongated member of cruciform shape in cross-section and having four longitudinally extending walls. Those longitudinally extending walls form four longitudinally extending channels 34A, 34B, 34C and 34D therebetween. It is through those channels that the flowable contents (the product) within the package can flow (as will be described later).

The anti-flow blocking member is mounted at the inward end of the tubular section of the fitment by four outwardly projecting stand-offs or legs 36. The forward end 38 of the anti-flow blocking member 34 is of hollow tubular shape having plural apertures or ports 40 equidistantly spaced about its periphery. Those ports are in fluid communication with the channels 34A-34D in the cruciform member. A cylindrical elastic sleeve or band 42 is disposed over the forward end 38 of the member 34 to normally seal the ports 40, thereby closing off the ends of the channels 34A-34D. That band 42, in cooperation with the ports 40, forms a valve. As will be described later the valve is arranged to automatically open when suction is applied to the fitment, e.g., such as when a probe of the dispensing apparatus is connected to the fitment and the pumping mechanism of the dispensing apparatus operated.

A cover 44, e.g., a foil member, is located over the free end of the outer collar section 32 of the fitment to seal that end of the fitment and thus keep out any foreign material from the interior of the fitment and thus from gaining ingress into the interior of the package. The cover 44 is arranged to be removed, e.g., peeled off or pierced, when the package is ready to be used to dispense its contents.

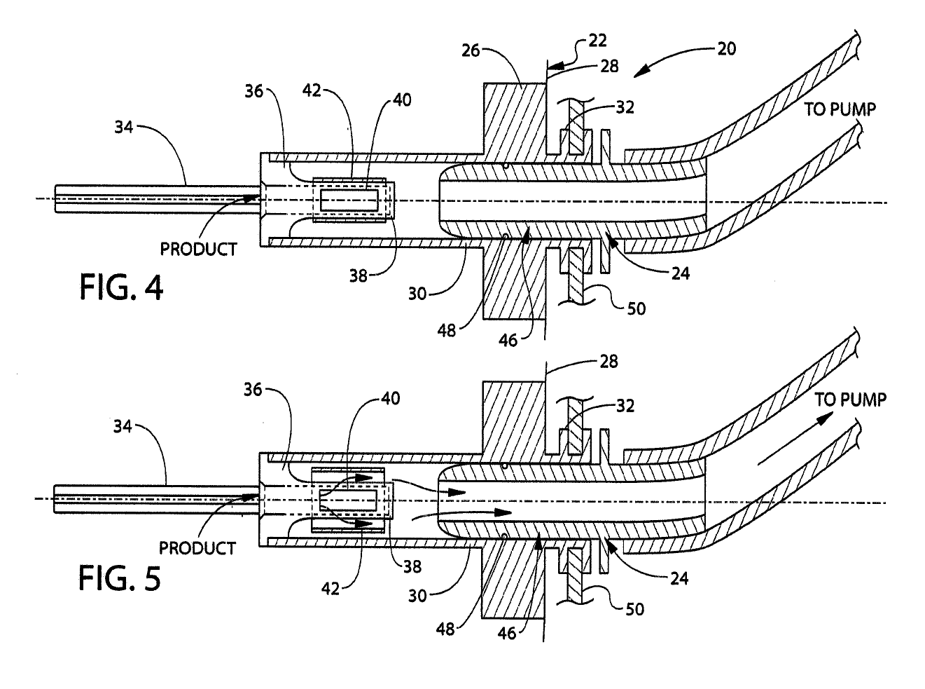

The use of the package to dispense its contents is as follows and is best seen in FIGS. 4 and 5. To that end, the package 20 is placed within a drawer 50 of the dispensing apparatus, with the collar portion 32 of the fitment 24 being received within a recess in the drawer to hold the package in place. The drawer with the package 20 therein is then moved to bring a probe 46 of the dispensing apparatus into the interior of the fitment. An O-ring 48 is provided in an annular groove on the outer surface of the probe to form a fluid-tight seal at the interface of the probe 46 and fitment.

The pump mechanism, e.g., a pump, of the dispensing apparatus can then be operated. That action produces negative pressure (suction) within the fitment, whereupon the resilient band 42 of the valve lifts off of the ports 40, as shown in FIG. 5, thereby opening the valve to enable the contents of the package to flow from the interior of the package through the channels 34A-34D, through the communicating ports 40 and into the probe, as shown by the path of the arrows in FIG. 5. Thus, the fluid contents of the package are dispensed through the fitment. When the pumping mechanism of the dispensing apparatus is stopped, the disappearance of suction in the probe results in the resilient band 42 collapsing back into engagement with the portions of the member 38 contiguous with the ports 40, thereby closing off those ports. This action prevents any remaining flowable material within the package from gaining egress through the fitment until the pumping mechanism is actuated again.

As should be appreciated by those skilled in the art, the fitment of the subject invention is simple in construction, can be made at low cost, is effective for enabling the fluid contents of a flexible package in which it is mounted to be dispensed without any impediment caused by the collapsing of the package's walls, yet prevents the accidental leakage of the fluid contents of the package through the fitment.

Without further elaboration the foregoing will so fully illustrate my invention that others may, by applying current or future knowledge, adopt the same for use under various conditions of service.

I claim:

1. A package for use with a dispensing apparatus to dispense a flowable material therefrom, said package comprising a flexible bag having plural wall portions defining an internal cavity and a fitment secured to at least one of said wall portions, said fitment being arranged to receive a probe of the dispensing apparatus having a pumping mechanism to pump the contents of the package through said fitment, said fitment comprising an anti-blocking member preventing wall portions of said package from collapsing to block said fitment when the contents of said package are pumped out, said fitment additionally comprising a valve which is normally closed and which opens upon the creation of negative pressure within said fitment as occasioned by the operation of the pumping mechanism.

2. The package of claim 1 wherein said anti-blocking member is an elongated member having plural longitudinally extending walls defining at least one channel therebetween along which the flowable materials of said package may flow.

3. The package of claim 3 wherein said anti-blocking member is an elongated member of generally cruciform cross-section.

4. The package of claim 1 wherein said valve comprises a hollow tubular member having at least one port therein and an elastic member covering said at least one port, said elastic member being arranged to be moved to expose said port upon the operation of the pumping mechanism.

5. The package of claim 2 wherein said valve comprises a hollow tubular member having at least one port therein and an elastic member covering said at least one port, said at least one channel being in fluid communication with said at least one port, said elastic member being arranged to be moved to expose said at least one port upon the operation of the pumping mechanism.

6. The package of claim 1 wherein said valve and said anti-blocking member are a unitary member.

7. The package of claim 5 wherein said valve and said anti-blocking member are a unitary member.

8. The package of claim 1 wherein said package includes a pair of wall portions sealed together, with a portion of said fitment interposed between said pair of wall portions.

9. The package of claim 8 wherein said portion of said fitment interposed between said pair of wall portions is boat shaped.

10. The package of claim 1 said fitment includes a collar portion.

11. The package of claim 10 including a cover disposed over said collar portion.

12. The package of claim 10 wherein the dispensing apparatus comprises a drawer having a wall and wherein said collar portion is arranged for disposition within a recess in the wall of the drawer.

13. A fitment for use in a package, the package being arranged for use with a dispensing apparatus to dispense a flowable material therefrom, the package comprising a flexible bag having plural wall portions defining an internal cavity, said fitment being arranged to be secured to at least one of the wall portions of the package and being arranged to receive a probe of the dispensing apparatus, the dispensing apparatus having a pumping mechanism to pump the contents of the package through said fitment, said fitment comprising an anti-blocking member arranged for preventing wall portions of the package from collapsing to block said fitment when the contents of the package are pumped out, said fitment additionally comprising a valve which is normally closed and which is arranged to open upon the creation of negative pressure within said fitment as occasioned by the operation of the pumping mechanism.

14. The fitment of claim 13 wherein said anti-blocking member is an elongated member having plural longitudinally extending walls defining at least one channel therebetween along which the flowable materials of the package may flow.

15. The fitment of claim 14 wherein said anti-blocking member is an elongated member of generally cruciform cross-section.

15. The fitment of claim 13 wherein said valve comprises a hollow tubular member having at least one port therein and an elastic member covering said at least one port, said elastic member being arranged to be moved to expose said port upon the operation of the pumping mechanism.

16. The fitment of claim 14 wherein said valve comprises a hollow tubular member having at least one port therein and an elastic member covering said at least one port, said at least one channel being in fluid communication with said at least one port, said elastic member being arranged to be moved to expose said at least one port upon the operation of the pumping mechanism.

17. The fitment of claim 13 wherein said valve and said anti-blocking member are a unitary member.

18. The fitment of claim 13 wherein a first portion of said fitment is arranged to be interposed between a pair of wall portions of the package and wherein said first portion of said fitment is boat shaped.

19. The fitment of claim 13 wherein said fitment includes a collar portion.

20. The fitment of claim 19 including a cover disposed over said collar portion.
